(19) United States
(12) Patent Application Publication
(10) Pub. No.: US 2014/0071245 A1
(43) Pub. Date: Mar. 13, 2014

(54) SYSTEM AND METHOD FOR ENHANCED STEREO IMAGING

(71) Applicants: Guanghua Gary Zhang, Sunnyvale, CA (US); Michael Lin, Fremont, CA (US); Patrick Shehane, Fremont, CA (US); Hugh Phu Nguyen, Milpitas, CA (US)

(72) Inventors: Guanghua Gary Zhang, Sunnyvale, CA (US); Michael Lin, Fremont, CA (US); Patrick Shehane, Fremont, CA (US); Hugh Phu Nguyen, Milpitas, CA (US)

(73) Assignee: NVIDIA CORPORATION, Santa Clara, CA (US)

(21) Appl. No.: 13/609,062

(22) Filed: Sep. 10, 2012

(51) Int. Cl. H04N 13/02

(52) U.S. Cl. 348/47; 348/E13.074

(57) ABSTRACT

A system and method for stereoscopic image capture. The method includes capturing a first image with a first camera and capturing a second image with a second camera. The second camera comprises a lower resolution sensor than a sensor of the first camera. The method further includes determining a third image based on adjusting the first image to a resolution of the lower resolution sensor of the second camera and generating a stereoscopic image comprising the second image and the third image.

### RELATED U.S. APPLICATIONS

This application claims the benefit of and priority to the copending provisional patent application, Ser. No. ______, Attorney Docket Number NVID-P-SC-11-0281-US1, entitled “SYSTEM AND METHOD FOR ENHANCED MONOIMAGING,” with filing date ______, ______, and hereby incorporated by reference in its entirety.

### FIELD OF THE INVENTION

Embodiments of the present invention are generally related to image capture.

### BACKGROUND OF THE INVENTION

As computer systems have advanced, processing power and speed have increased substantially. At the same time, the processors and other computer components has decreased in size allowing them to be part of an increasing number of devices. Cameras and mobile devices have benefited significantly from the advances in computing technology.

The addition of camera functionality to mobile devices has made taking photographs and video quite convenient. In order to compete with traditional cameras, mobile devices are increasingly being fitted with higher megapixel capacity and higher quality cameras. As stereoscopic three dimensional (S3D) movies have become popular, an increasingly popular option is to have two cameras on the mobile device to allow capture of S3D images and video. Conventional solutions often include two identical high resolution cameras, each with a high megapixel resolution. Unfortunately, the inclusion of two such high end cameras significantly increases the cost and power usage of mobile devices.

Thus, while two high megapixel cameras may allow taking high quality S3D images or video, the inclusion of such high megapixel cameras significantly increases the cost and power usage of the device and may unduly increase the size of the device.

### SUMMARY OF THE INVENTION

Embodiments of the present invention are operable to provide enhanced stereoscopic imaging including enhanced stereoscopic imaging and video capture. In one embodiment, a second camera of a multi camera device has a lower resolution than a first camera thereby reducing the cost and power consumption of the device. The lower resolution camera may further be operable for faster image capture than the higher resolution camera. Embodiments of the present invention are operable to downsample or scale an image captured by the higher resolution camera to the resolution of the lower resolution camera thereby allowing stereoscopic image and video capture at the resolution of the lower resolution camera. The downsampling of an image from the higher resolution camera advantageously reduces bandwidth and bus requirements. Embodiments of the present invention are further operable to provide enhancements in the following: automatic focus, automatic exposure, automatic color balancing, detection of objects of interest, and other functionality (e.g., where a second camera comprises a depth sensor). Embodiments of the present invention are further operable to allow capture of high dynamic range images and images of extended depth of focus.

In one embodiment, the present invention is directed toward a method for stereoscopic image capture. The method includes capturing a first image with a first camera and capturing a second image with a second camera of a multi camera device. The second camera comprises a lower resolution sensor than a sensor of the first camera. The second camera may be operable to capture the second image in less time than the first camera is operable to capture the first image. The first camera may operate at a first power consumption level and second camera operates at a second power consumption level where the first power consumption level is greater than the second power consumption level. The first image and the second image may be captured substantially simultaneously. In one embodiment, the first camera is operable to capture an image while the second camera is capturing video.

The method further includes determining a third image based on adjusting the first image to a resolution of the lower resolution sensor of the second camera and generating a stereoscopic image comprising the second image and the third image. The stereoscopic image may be a video frame. Adjusting the first image may comprise downsampling by determining an average value of a plurality of pixels of the first image to include in the third image. The method may further comprise determining a first region of interest in the first image and determining a second region of interest in the second image. Adjusting may then comprise adjusting the first image is based on matching the first region of interest with the second region of interest (e.g., matching the location).

In one embodiment, the present invention is implemented as a system for image capture. The system includes an image capture module operable for capturing a first image with a first camera and operable for capturing a second image with a second camera and a downsampling module operable to downsample the first image to the second resolution to form a third image. The first image has a first resolution and the second image has a second resolution where second resolution is lower than the first resolution. In one embodiment, the downsampling module is operable to downsample the first image by averaging a plurality of pixels of the first image to include in the third image. In one exemplary embodiment, the first camera comprises a first sensor and the second camera comprises a second sensor where the first sensor and the second sensor share a common aperture. The image capture module may be operable to capture the first image and the second image coincidentally simultaneously. The second camera may be operable to capture the second image in less time than the first camera is operable to capture the first image. In one embodiment, the first camera operates at a first power consumption level and the second camera operates at a second power consumption level where the first power consumption level is greater than the second power consumption level. The system further includes an image output module operable to output a stereoscopic image comprising the second image and the third image. The stereoscopic image may be a video frame.

In another embodiment, the present invention is directed to a computer-readable storage medium having stored thereon, computer executable instructions that, if executed by a computer system cause the computer system to perform a method of capturing a stereoscopic image. The method includes capturing a first image with a first camera and capturing a second image with a second camera. The first image has a first resolution and the second image has a second resolution where the second resolution is lower than the first resolution. The first image and the second image may be captured substantially simultaneously. In one embodiment, the first camera comprises a first sensor and the second camera comprises a second sensor where the first sensor and the second sensor share a single aperture. The method further includes determining a third image based on downscaling the first image to the second resolution and outputting a stereoscopic image comprising the second image and the third image. The stereoscopic image may be a video frame. The scaling of the first image may comprise determining an average value of a plurality of pixels of the first image to include in the third image.

### BRIEF DESCRIPTION OF THE DRAWINGS

Embodiments of the present invention are illustrated by way of example, and not by way of limitation, in the figures of the accompanying drawings and in which like reference numerals refer to similar elements.

FIG. 1 shows a computer system in accordance with one embodiment of the present invention.

FIG. 2 shows an exemplary operating environment in accordance with one embodiment of the present invention.

FIG. 3 shows a block diagram of exemplary components of a system for stereo image or video capture in accordance with one embodiment of the present invention.

FIG. 4 shows a flowchart of an exemplary electronic component controlled process for stereo image and video capture in accordance with one embodiment of the present invention.

FIG. 5 shows a block diagram of exemplary computer system and corresponding modules, in accordance with one embodiment of the present invention.

### DETAILED DESCRIPTION OF THE INVENTION

Reference will now be made in detail to the preferred embodiments of the present invention, examples of which are illustrated in the accompanying drawings. While the invention will be described in conjunction with the preferred embodiments, it will be understood that they are not intended to limit the invention to these embodiments. On the contrary, the invention is intended to cover alternatives, modifications and equivalents, which may be included within the spirit and scope of the invention as defined by the appended claims. Furthermore, in the following detailed description of embodiments of the present invention, numerous specific details are set forth in order to provide a thorough understanding of the present invention. However, it will be recognized by one of ordinary skill in the art that the present invention may be practiced without these specific details. In other instances, well-known methods, procedures, components, and circuits have not been described in detail as not to unnecessarily obscure aspects of the embodiments of the present invention.

### Notation and Nomenclature:

Some portions of the detailed descriptions, which follow, are presented in terms of procedures, steps, logic blocks, processing, and other symbolic representations of operations on data bits within a computer memory. These descriptions and representations are the means used by those skilled in the data processing arts to most effectively convey the substance of their work to others skilled in the art. A procedure, computer executed step, logic block, process, etc., is here, and generally, conceived to be a self-consistent sequence of steps or instructions leading to a desired result. The steps are those requiring physical manipulations of physical quantities. Usually, though not necessarily, these quantities take the form of electrical or magnetic signals capable of being stored, transferred, combined, compared, and otherwise manipulated in a computer system. It has proven convenient at times, principally for reasons of common usage, to refer to these signals as bits, values, elements, symbols, characters, terms, numbers, or the like.

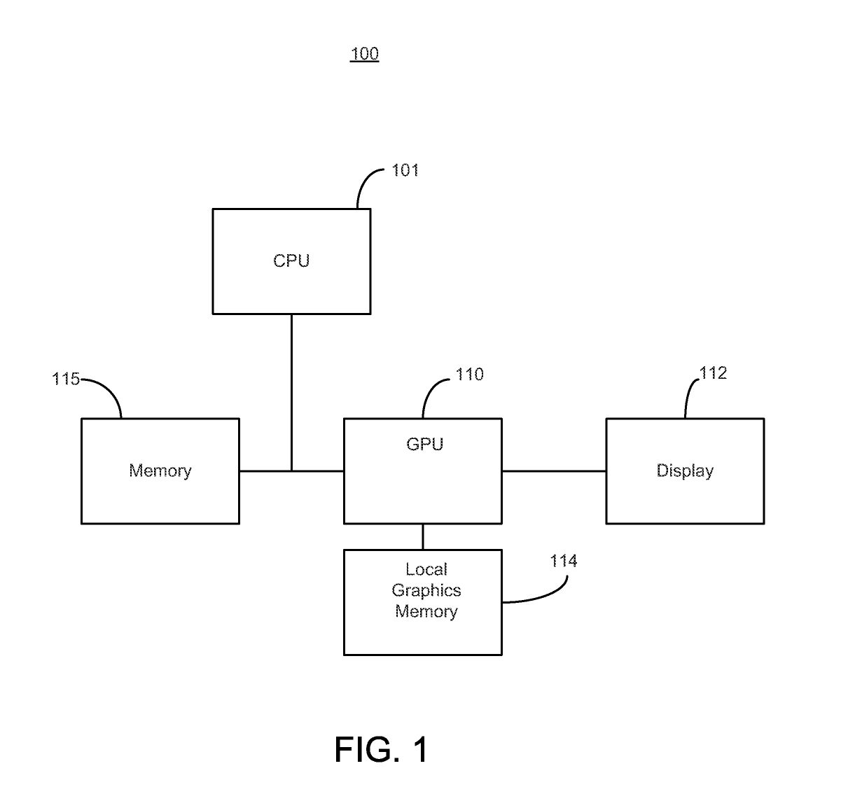

It should be borne in mind, however, that all of these and similar terms are to be associated with the appropriate physical quantities and are merely convenient labels applied to these quantities. Unless specifically stated otherwise as apparent from the following discussions, it is appreciated that throughout the present invention, discussions utilizing terms such as “processing” or “accessing” or “executing” or “storing” or “rendering” or the like, refer to the action and processes of an integrated circuit (e.g., computing system 100 of FIG. 1), or similar electronic computing device, that manipulates and transforms data represented as physical (electronic) quantities within the computer system's registers and memories into other data similarly represented as physical quantities within the computer system memories or registers or other such information storage, transmission or display devices.

### Computer System Environment

FIG. 1 shows an exemplary computer system 100 in accordance with one embodiment of the present invention. Computer system 100 depicts the components of a generic computer system in accordance with embodiments of the present invention providing the execution platform for certain hardware-based and software-based functionality. In general, computer system 100 comprises at least one CPU 101, a system memory 115, and at least one graphics processor unit (GPU) 110. The CPU 101 can be coupled to the system memory 115 via a bridge component/memory controller (not shown) or can be directly coupled to the system memory 115 via a memory controller (not shown) internal to the CPU 101. The GPU 110 may be coupled to a display 112. One or more additional GPUs can optionally be coupled to system 100 to further increase its computational power. The GPU(s) 110 is coupled to the CPU 101 and the system memory 115. The GPU 110 can be implemented as a discrete component, a discrete graphics card designed to couple to the computer system 100 via a connector (e.g., AGP slot, PCI-Express slot, etc.), a discrete integrated circuit die (e.g., mounted directly on a motherboard), or as an integrated GPU included within the integrated circuit die of a computer system chipset component (not shown). Additionally, a local graphics memory 114 can be included for the GPU 110 for high bandwidth graphics data storage.

The CPU 101 and the GPU 110 can also be integrated into a single integrated circuit die and the CPU and GPU may share various resources, such as instruction logic, buffers, functional units and so on, or separate resources may be provided for graphics and general-purpose operations. The GPU may further be integrated into a core logic component. Accordingly, any or all the circuits and/or functionality described herein as being associated with the GPU 110 can also be implemented in, and performed by, a suitably equipped CPU 101. Additionally, while embodiments herein may make reference to a GPU, it should be noted that the described circuits and/or functionality can also be implemented and other types of processors (e.g., general purpose or other special-purpose coprocessors) or within a CPU.

System 100 can be implemented as, for example, a desktop computer system or server computer system having a powerful general-purpose CPU 101 coupled to a dedicated graphics rendering GPU 110. In such an embodiment, components can be included that add peripheral buses, specialized audio/video components, IO devices, and the like. Similarly, system 100 can be implemented as a handheld device (e.g., cellphone, etc.), direct broadcast satellite (DBS)/terrestrial set-top box or a set-top video game console device such as, for example, the Xbox®, available from Microsoft Corporation of Redmond, Wash., or the PlayStation3®, available from Sony Computer Entertainment Corporation of Tokyo, Japan. System 100 can also be implemented as a “system on a chip”, where the electronics (e.g., the components 101, 115, 110, 114, and the like) of a computing device are wholly contained within a single integrated circuit die. Examples include a hand-held instrument with a display, a car navigation system, a portable entertainment system, and the like.

### Exemplary Operating Environment:

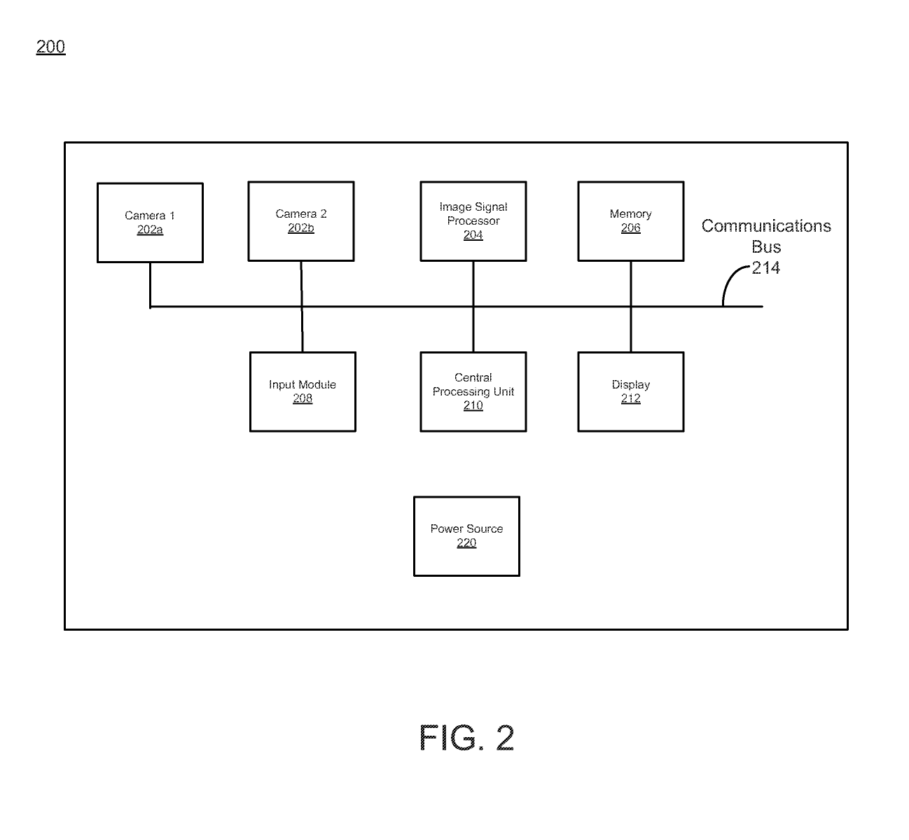

FIG. 2 shows an exemplary operating environment or “device” in accordance with one embodiment of the present invention. System 200 includes cameras 202a-b, image signal processor (ISP) 204, memory 206, input module 208, central processing unit (CPU) 210, display 212, communications bus 214, and power source 220. Power source 220 provides power to system 200 and may be a DC or AC power source. System 200 depicts the components of a basic system in accordance with embodiments of the present invention providing the execution platform for certain hardware-based and software-based functionality. Although specific components are disclosed in system 200, it should be appreciated that such components are examples. That is, embodiments of the present invention are well suited to having various other components or variations of the components recited in system 200. It is appreciated that the components in system 200 may operate with other components other than those presented, and that not all of the components of system 200 may be required to achieve the goals of system 200.

CPU 210 and the ISP 204 can also be integrated into a single integrated circuit die and CPU 210 and ISP 204 may share various resources, such as instruction logic, buffers, functional units and so on, or separate resources may be provided for image processing and general-purpose operations. System 200 can be implemented as, for example, a digital camera, cell phone camera, portable device (e.g., audio device, entertainment device, handheld device), webcam, video device (e.g., camcorder) and the like.

In one embodiment, cameras 202a-b capture light via a first lens and a second lens (not shown), respectively, and convert the light received into a signal (e.g., digital or analog). Cameras 202a-b may comprise any of a variety of optical sensors including, but not limited to, complementary metal-oxide-semiconductor (CMOS) or charge-coupled device (CCD) sensors. Cameras 202a-b are coupled to communications bus 214 and may provide image data received over communications bus 214. Cameras 202a-b may each comprise respective functionality to determine and configure respective optical properties and settings including, but not limited to, focus, exposure, color or white balance, and areas of interest (e.g., via a focus motor, aperture control, etc.).

Image signal processor (ISP) 204 is coupled to communications bus 214 and processes the signal generated by cameras 202a-b, as described herein. More specifically, image signal processor 204 may process data from sensors 202a-b for storing in memory 206. For example, image signal processor 204 may compress and determine a file format for an image to be stored in within memory 206.

Input module 208 allows entry of commands into system 200 which may then, among other things, control the sampling of data by cameras 202a-b and subsequent processing by ISP 204. Input module 208 may include, but it not limited to, navigation pads, keyboards (e.g., QWERTY), up/down buttons, touch screen controls (e.g., via display 212) and the like.

Central processing unit (CPU) 210 receives commands via input module 208 and may control a variety of operations including, but not limited to, sampling and configuration of cameras 202a-b, processing by ISP 204, and management (e.g., addition, transfer, and removal) of images and/or video from memory 206.

### Exemplary Systems and Methods for Enhanced Monoimaging

Embodiments of the present invention are operable to provide enhanced stereoscopic imaging including enhanced stereoscopic imaging and video capture. In one embodiment, a second camera has a lower resolution than a first camera thereby reducing the overall cost and power consumption of a device. The lower resolution camera may further be operable for faster image capture than the higher resolution camera. Embodiments of the present invention are operable to downsample or scale an image captured by the higher resolution camera to the resolution of the lower resolution camera thereby allowing stereoscopic image and video capture at the resolution of the lower resolution camera. The downsampling of an image from the higher resolution camera advantageously reduces the bandwidth and bus requirements. Embodiments of the present invention are further operable to provide enhanced: automatic focus, automatic exposure, automatic color balancing, detection of objects of interest, and functionality (e.g., where a second camera comprises a depth sensor). Embodiments of the present invention are further operable for capture of high dynamic range images and extended depth of focus images.

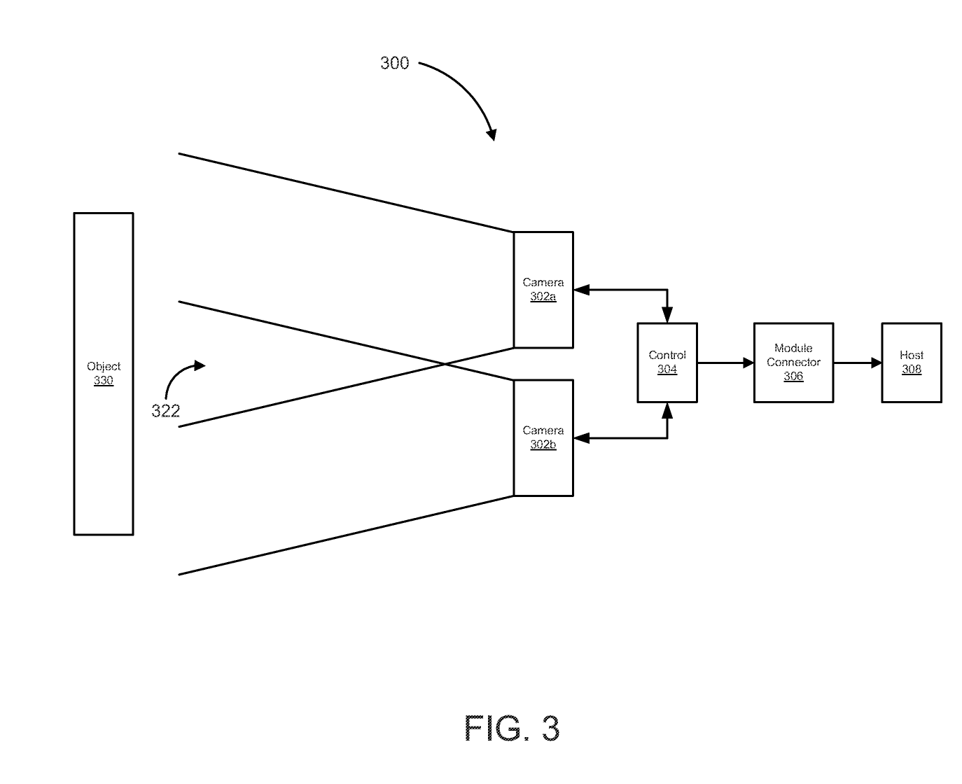

FIG. 3 shows a block diagram of exemplary components of a system for stereo image or video capture in accordance with one embodiment of the present invention. Exemplary system 300 or “device” depicts components operable for use in capturing a stereoscopic image or video (e.g., S3D) with cameras 302a-b where one camera (e.g., camera 302b) has a lower resolution than the other camera (e.g., camera 302a). Exemplary system 300 includes cameras 302a-b, control module 304, module connector 306, and host 308.

Cameras 302a-b may share parallel or substantially parallel optical axes (e.g., face the same direction). Cameras 302a-b may have similar or different fields of view. In one embodiment, cameras 302a-b may be placed in close proximity with overlapped field of view 322. Cameras 302a-b may be operable in conjunction to capture S3D images and video. In one embodiment, cameras 302a-b each have respective polarization filters to facilitate capture of S3D images and video.

Control module 304 is operable to output an image or video according to the pins of module connector 306 in a plurality of ways. In one exemplary embodiment, control module 304 is operable to output an image from camera 302a, output an image from camera 302b, and output a composite image formed from half rows or columns simultaneously captured from cameras 302a and 302b. In another exemplary embodiment, control module 304 is operable to output an image pair captured time sequentially from cameras 302a and 302b where the module data path has the capacity to transmit synchronically data from cameras 302a-302b to the host at twice the speed of a single camera. Control module 304 may be operable to downsample or scale an image captured by a higher resolution camera (e.g., camera 302a) to the resolution of the lower resolution camera (e.g., camera 302b), as described herein. In another embodiment, control module 304 is operable to output a dual image formed (e.g., S3D) with full images captured simultaneously from cameras 302a-b where the module data path has the capacity to transmit synchronically both data from cameras 302a and 302b to host 308 at the same speed as that from a single camera. In one embodiment, host 308 is operable to process (e.g., compress and format) and store images and video on a storage medium.

Cameras 302a-b may have fixed focus or adjustable focus. Cameras 302a-b may be each be independent camera modules. Cameras 302a-b may further be two cameras using a single imaging sensor with separate optical elements using different portions of a single imaging sensor.

Cameras 302a-b may have the same type of image sensor or may have different types (e.g., image or depth sensors). In one embodiment, cameras 302a and 302b are identical and cameras 302a-b are operable for capturing full resolution stereo or half resolution stereo images with a reduced bandwidth requirement to the host (e.g., host 308).

In one exemplary embodiment, where cameras 302a and 302b are identical, images or video of the same scene can be captured at twice the speed of a single camera when configured as time sequential capture. For example, if cameras 302a-b are each operable to capture 30 frames or images per second, in combination cameras 302a-b may capture 60 images per second (e.g., with a slight time offset between each capture).

Cameras 302a-b may further have the same or different imaging resolutions. In one embodiment, cameras 302a-b may be have different resolution optical sensors. For example, camera 302a may have a higher resolution (e.g., 13 megapixels) and camera 302b may have a lower resolution (e.g., 2 megapixels). The lower resolution camera (e.g., camera 302b) may thus analyze and make determinations about the environment around exemplary system 300. As described in related copending non-provisional patent application, Ser. No. ______, Attorney Docket Number NVID-P-SC-11-0281-US1, entitled “SYSTEM AND METHOD FOR ENHANCED MONOIMAGING,” with filing date ______, and hereby incorporated by reference in its entirety, one of cameras 302a-b may be operable for determining automatic focus, automatic exposure, automatic color balance, and areas of interest and passing the information to the other camera.

Cameras 302a-b may further be operable to capture high dynamic range images and extended depth of focus images as described in the aforementioned non-provisional patent application. The determination by one camera (e.g., camera 302b) may be done in less time and with less power than would be needed by (e.g., camera 302a). It is appreciated that either of cameras 302a-b may have a relatively higher resolution sensor and embodiments are not limited to whether camera 302a has a higher resolution than camera 302b. In one embodiment, when cameras 302a-b are different, camera 302a operates as a primary camera or master camera and camera 302b operates as an auxiliary or slave camera when images or video are captured by camera 302a.

Cameras 302a and 302b may thus be different but have complementary performance. Cameras 302a-b may have the same or different output frame rates and capture speeds. Camera 302a may be operable for a higher resolution capture (e.g., 13 megapixels) at a normal camera speed while camera 302b has a higher speed with lower resolution (e.g., 2 megapixels). Higher resolution images or video may be captured with camera 302a and higher speed images or video may be captured with camera 302b (e.g., high-definition (HD) video). Camera 302b may thus have a lower cost than camera 302a thereby allowing a system to have two cameras while also having reduced cost. Having a second camera of a lower resolution (e.g., camera 302b) reduces the cost of a device as well as bandwidth (e.g., of a bus for transmitting data from cameras 302a-b).

Camera 302b may thus be operable for faster configuration determination relative to camera 302a. For example, camera 302b may be operable for determining focus, exposure, color balance, and areas of interest in less time than camera 302a. In one embodiment, the use of the lower resolution camera (e.g., camera 302b) to make various determinations (e.g., focus, exposure, color balance, and areas of interest) saves power over using the higher resolution camera (e.g., camera 302a) to do same functions. For example, camera 302b may have a lower resolution (e.g., 2 megapixels), have a higher capture speed than camera 302a, and lower power consumption than camera 302a. The lower resolution camera (e.g., camera 302b) may thus be able to make optical property determinations faster with less power than the higher resolution camera (e.g., camera 302a). In one exemplary embodiment, camera 302b is operable to periodically or continuously make optical property or configuration determinations (e.g., focus, exposure, color balance, and areas of interest) and send the results of the optical property determinations to camera 302a which then may adjust accordingly.

In one exemplary embodiment, camera 302b may make configuration determinations while camera 302a is used to capture video. Camera 302b may thus make configuration determinations without destroying, blowing out, making the video too bright or too dark, or out of focus. Camera 302b may further make configuration determinations taking longer than the time for camera 302a to capture a frame of video. Camera 302b may thereby make more accurate configuration determinations that might otherwise be difficult within the time to capture a single frame (e.g., 1/30 of a second for 30 frames per second (fps) video). In one embodiment, the lower resolution camera (e.g., camera 302b) measures the light of a scene (e.g., including object 330) and passes the aperture or gain to setting the higher resolution camera (e.g., camera 302a).

In another exemplary embodiment, cameras 302a and 302b may have different spectral filters thereby allowing cameras 302a and 302b to capture images under different lighting conditions and different spectrums of light. In one embodiment, a probing light may be sent for object detection that is in a portion of the spectrum exclusive to camera 302b and not received by primary camera 302a. For example, camera 302a may have an IR filter which allows camera 302b (without an IR filter) to operate under low light conditions under which camera 302a cannot. Use of such an IR filter may further allow configuration determinations (e.g., automatic focus, automatic exposure, automatic color balancing, and areas of interest) to be done in low lighting or dark environments.

Embodiments of the present invention are further operable for use with gradient filters and neutral density filters. Band pass filters may also be used such that one camera (e.g., camera 302a) operates in a first portion of the spectrum and the other camera (e.g., camera 302b) operates in an adjacent second portion of the spectrum thereby allowing use of each camera in exclusive portions of the spectrum.

Embodiments of the present invention may further have a second camera (e.g., camera 302b) of a different type than the first camera (e.g., camera 302a). In one embodiment, camera 302b is a depth or time of flight sensor operable to determine the distances of object pixels or pixels corresponding to objects within a common field of view and transmit such information to a high resolution camera (e.g., camera 302a). In another embodiment, camera 302a may further request depth information from camera 302b.

### Exemplary Stereo Image or Video Capture

Stereo or 3D image capture may be performed with two cameras and storing a corresponding 3D image comprising two images each from a different view point. Capturing stereo images with two high resolution (e.g., 10 or 13 Megapixel) cameras may use large amounts of storage space while a display of the device may have a resolution of approximately two Megapixels (e.g., high definition such as 1080p). Embodiments of the present invention are operable for stereo image capture with a primary camera having a relatively higher resolution (e.g., camera 302a) in conjunction with a relatively lower resolution camera (e.g., camera 302b). It is noted that a device comprising a relatively high resolution camera and a relatively low resolution camera has a lower or reduced cost than a device comprising two high resolution cameras. In one embodiment, the lower resolution camera (e.g., camera 302b) is operable to perform image captures faster and use less power than the higher resolution camera (e.g., camera 302a).

As display devices often have a high definition resolution (e.g., 1080i/p), two dimensional (2D) and 3D video is often desired at the corresponding high definition resolution. Further, a device (e.g., smartphone) often has a high definition display with preview images displayed and captured at a high definition resolution. In one embodiment, a lower resolution or high definition camera may be used for video capture (e.g., 2D) and both cameras used for capturing high definition stereoscopic video (e.g., S3D). In one exemplary embodiment, images captured from the higher resolution camera (e.g., camera 302a) are used as preview image displayed to a user while a lower resolution camera (e.g., camera 302a) makes optical determinations (e.g., focus, exposure, color balance, and areas of interest).

For example, where camera 302b has a lower resolution than camera 302a, images captured with camera 302a may be reduced in resolution (e.g., downsampled or subsampled) to form a stereoscopic (3D) image with images captured from camera 302b. In one embodiment, the resolution reduction may be achieved through pixel decimations by skipping pixels, binning (e.g., summing adjacent pixels), averaging, framing, or pixel sampling. In other words, a subset of pixels from the higher resolution camera (e.g., camera 302a) may be selected for the stereoscopic image or video frame to match the resolution of the image captured by the lower resolution camera (e.g., camera 302b). It is appreciated that for stereoscopic image capture each image should have the same size, optical properties (e.g., focus, exposure, color balance, etc.), and color to allow the eyes of someone viewing the stereoscopic image to focus on the differences in geometry.

In one embodiment, pixels of the higher resolution image are averaged (e.g., using a 2×2 pixel blocks and averaging the value of the 4 pixels together). In another embodiment, each camera may have a different field of view and a region of interest (e.g., face or object) is used to match up each field of view (e.g., via the location of each respective region of interest) and then the image from the higher resolution from the higher resolution camera is downsampled (e.g., averaging or binning) to the resolution of the image from the lower resolution camera.

In one exemplary embodiment, the lower resolution camera (e.g., camera 302b) may be used for video capture, while the higher resolution camera (e.g., camera 302a) may be used for still image capture (e.g., simultaneously).

In one embodiment, control module 304 is operable to perform the downsampling on the image from the higher resolution camera (e.g., camera 302a) before the image is sent to host 308. Using control module 304 in this manner reduces the bandwidth requirements for sending images from the higher resolution camera or sensor when capturing stereoscopic images or video thereby allowing a smaller bus to be used which reduces cost and power requirements.

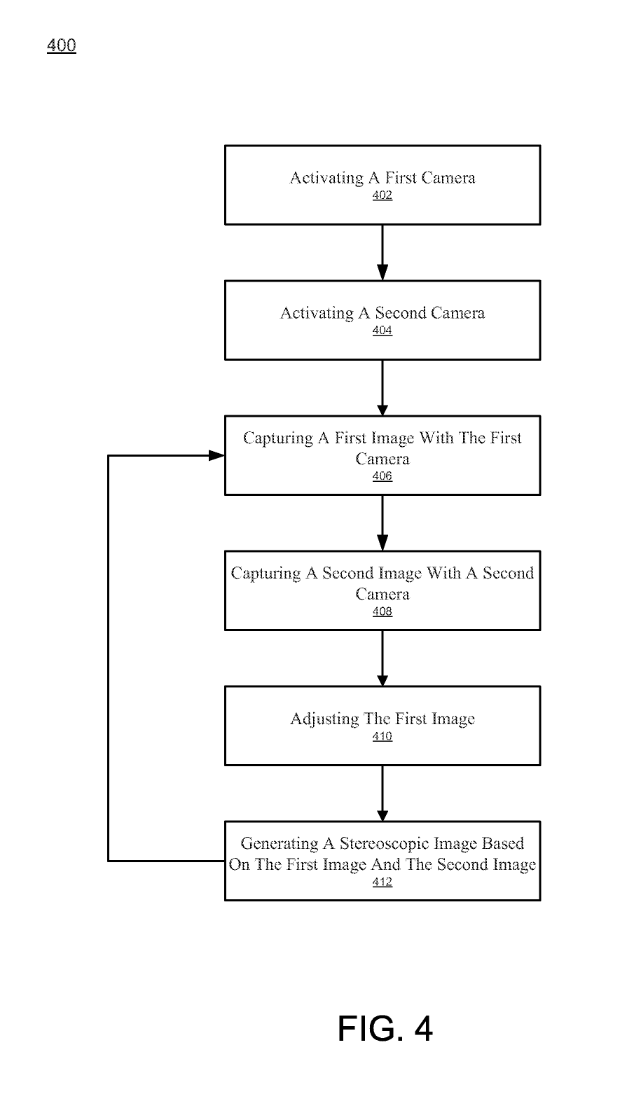

With reference to FIG. 4, flowchart 400 illustrates example functions used by various embodiments of the present invention. Although specific function blocks (“blocks”) are disclosed in flowchart 400, such steps are examples. That is, embodiments are well suited to performing various other blocks or variations of the blocks recited in flowchart 400. It is appreciated that the blocks in flowchart 400 may be performed in an order different than presented, and that not all of the blocks in flowchart 400 may be performed.

FIG. 4 shows a flowchart of an exemplary electronic component controlled process for stereo image and video capture in accordance with one embodiment of the present invention. In one embodiment, FIG. 4 depicts a process for capturing and outputting stereoscopic images or stereoscopic video with cameras of different optical properties (e.g., different resolutions such as camera 302b having a lower resolution than camera 302a).

At block 402, a first camera is activated. A device may have two cameras which may be activated or turned on independently.

At block 404, a second camera is activated. The first camera may have a higher resolution than the second camera. The first camera and the second camera may be activated for stereoscopic image or stereoscopic video frame capture or preview stereoscopic image capture.

The first camera may operate at a power consumption level that is greater than the power consumption level of the second camera. The second camera may further be operable to capture an image in less time than the first camera. In one embodiment, the first camera comprises a first sensor and the second camera comprises a second sensor and the first sensor and the second sensor share a single aperture. In another embodiment, the first camera may be operable to capture an image while the second camera is capturing video (e.g., simultaneously).

At block 406, a first image is captured with the first camera. In one embodiment, the first image may be a preview image which is presented or displayed on a screen of the device to a user. Preview images captured by the first camera may have a lower resolution than the full resolution that the first camera is capable of capturing. The first image captured may also be an image for stereoscopic image or stereoscopic video capture.

At block 408, a second image is captured with the second camera. The second camera may comprise a lower resolution sensor than a sensor of the first camera. In one exemplary embodiment, the first image from the first camera has a first resolution and the second image from the second has a second resolution where the second resolution is lower than the first resolution. The first image and the second image may be captured simultaneously.

At block 410, the first image is adjusted or scaled. In one embodiment, a third image is determined based on adjusting or scaling the first image to a resolution of the lower resolution sensor of the second camera. The adjusting of the first image may comprise determining an average value of a plurality of pixels of the first image (e.g., average value of 2×2 pixels blocks of the first image). In one embodiment, the adjusting may comprise determining a first region of interest in the first image and determining a second region of interest in the second image. The adjusting of the first image may then be based on matching the first region of interest with the second region of interest.

At block 412, a stereoscopic image is generated based on the first image and second image. In one embodiment, a stereoscopic image comprising the second image and the adjusted first image is generated and sent or output. The stereoscopic image may be a video frame. The first image and second image may be part of a stereoscopic preview image or may be a stereoscopic image or stereoscopic video frame captured at the resolution of the second or lower resolution camera. Block 406 may then be performed as the first camera is used to capture another image and the second camera is used to capture another image thereby capturing images for another stereo image or stereo video frame.

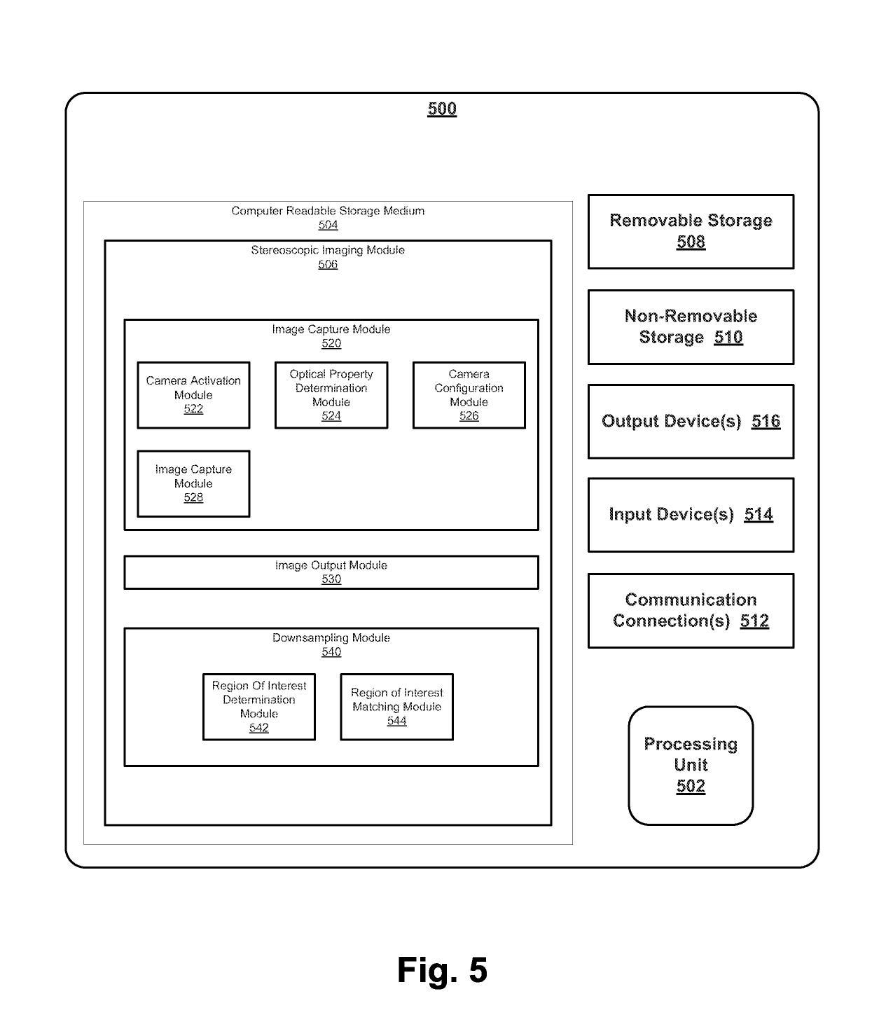

FIG. 5 illustrates example components used by various embodiments of the present invention. Although specific components are disclosed in computing system environment 500, it should be appreciated that such components are examples. That is, embodiments of the present invention are well suited to having various other components or variations of the components recited in computing system environment 500. It is appreciated that the components in computing system environment 500 may operate with other components than those presented, and that not all of the components of system 500 may be required to achieve the goals of computing system environment 500.

FIG. 5 shows a block diagram of an exemplary computing system environment 500, in accordance with one embodiment of the present invention. With reference to FIG. 5, an exemplary system module for implementing embodiments includes a general purpose computing system environment, such as computing system environment 500. Computing system environment 500 may include, but is not limited to, servers, desktop computers, laptops, tablet PCs, mobile devices, and smartphones. In its most basic configuration, computing system environment 500 typically includes at least one processing unit 502 and computer readable storage medium 504. Depending on the exact configuration and type of computing system environment, computer readable storage medium 504 may be volatile (such as RAM), non-volatile (such as ROM, flash memory, etc.) or some combination of the two. Portions of computer readable storage medium 504 when executed facilitate image or video capture (e.g., process 400).

Additionally, computing system environment 500 may also have additional features/functionality. For example, computing system environment 500 may also include additional storage (removable and/or non-removable) including, but not limited to, magnetic or optical disks or tape. Such additional storage is illustrated in FIG. 5 by removable storage 508 and non-removable storage 510. Computer storage media includes volatile and nonvolatile, removable and non-removable media implemented in any method or technology for storage of information such as computer readable instructions, data structures, program modules or other data. Computer readable medium 504, removable storage 508 and nonremovable storage 510 are all examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by computing system environment 500. Any such computer storage media may be part of computing system environment 500.

Computing system environment 500 may also contain communications connection(s) 512 that allow it to communicate with other devices. Communications connection(s) 512 is an example of communication media. Communication media typically embodies computer readable instructions, data structures, program modules or other data in a modulated data signal such as a carrier wave or other transport mechanism and includes any information delivery media. The term computer readable media as used herein includes both storage media and communication media.

Communications connection(s) 512 may allow computing system environment 500 to communication over various networks types including, but not limited to, fibre channel, small computer system interface (SCSI), Bluetooth, Ethernet, Wi-fi, Infrared Data Association (IrDA), Local area networks (LAN), Wireless Local area networks (WLAN), wide area networks (WAN) such as the internet, serial, and universal serial bus (USB). It is appreciated the various network types that communication connection(s) 512 connect to may run a plurality of network protocols including, but not limited to, transmission control protocol (TCP), internet protocol (IP), real-time transport protocol (RTP), real-time transport control protocol (RTCP), file transfer protocol (FTP), and hypertext transfer protocol (HTTP).

Computing system environment 500 may also have input device(s) 514 such as a keyboard, mouse, pen, voice input device, touch input device, remote control, etc. Output device(s) 516 such as a display, speakers, etc. may also be included. All these devices are well known in the art and are not discussed at length.

In one embodiment, computer readable storage medium 504 includes stereoscopic imaging module 506. Stereoscopic imaging module 506 includes image capture module 520, image output module 530, and downsampling module 540.

Image capture module 520 is operable for capturing a first image with a first camera (e.g., camera 302a) and operable for capturing a second image with a second camera (e.g., camera 302b). In one embodiment, the first image has a first resolution and the second image has a second resolution where the second resolution is lower than the first resolution. In exemplary embodiment, image capture module 520 is operable to capture the first image and the second image simultaneously. In one embodiment, the second camera is operable to capture the second image in less time than the first camera is operable to capture the first image. The first camera may operate at a first power consumption level and the second camera operates at a second power consumption level where the first power consumption level is greater than the second power consumption level. In one embodiment, the first camera comprises a first sensor and the second camera comprises a second sensor and the first sensor and the second sensor share a single aperture (e.g., as shown in FIG. 5).

Downsampling module 540 is operable to downsample the first image to the resolution of the lower resolution camera to form a third image. In one embodiment, downsampling module 540 may be operable to downsample the first image by averaging a plurality of pixels of the first image, as described herein.

In one exemplary embodiment, downsampling module 540 includes region of interest determination module 542 and region of interest matching module 544. Region of interest determination module 542 is operable to determine a first region of interest of the first image and operable to determine a second region of interest of the second image, as described herein. Region of interest matching module 544 is operable to match the first region of interest with the second region of interest thereby allowing downsampling based on the matching of the first region of interest and the second region of interest, as described herein.

Image output module 530 is operable to output a stereoscopic image comprising the second image and the third image (e.g., downsampled first image). The stereoscopic image may be a video frame. In one embodiment, image output 530 may compress and format (e.g., 3D image format) and output the stereoscopic image to storage (e.g., hard drive or flash memory).

The foregoing descriptions of specific embodiments of the present invention have been presented for purposes of illustration and description. They are not intended to be exhaustive or to limit the invention to the precise forms disclosed, and many modifications and variations are possible in light of the above teaching. The embodiments were chosen and described in order to best explain the principles of the invention and its practical application, to thereby enable others skilled in the art to best utilize the invention and various embodiments with various modifications as are suited to the particular use contemplated. It is intended that the scope of the invention be defined by the claims appended hereto and their equivalents.

What is claimed is:

1. A method for stereoscopic image capture, said method comprising:
capturing a first image with a first camera;
capturing a second image with a second camera, wherein said second camera comprises a lower resolution sensor than a sensor of said first camera;
determining a third image based on adjusting said first image to a resolution of said lower resolution sensor of said second camera; and
generating a stereoscopic image comprising said second image and said third image.

2. The method as described in claim 1 wherein said stereoscopic image is a video frame.

3. The method as described in claim 1 wherein said first image and said second image are captured substantially simultaneously.

4. The method as described in claim 1 wherein said second camera is operable to capture said second image in less time than said first camera is operable to capture said first image.

5. The method as described in claim 1 wherein said first camera operates at a first power consumption level and said second camera operates at a second power consumption level, and wherein said first power consumption level is greater than said second power consumption level.

6. The method as described in claim 1 wherein said adjusting said first image comprises downsampling by determining an average value of a plurality of pixels of said first image to include in said third image.

7. The method as described in claim 1 further comprising:
determining a first region of interest in said first image;
determining a second region of interest in said second image, wherein said adjusting of said first image is based on matching said first region of interest with said second region of interest.

8. The method as described in claim 1 wherein said first camera is operable to capture an image while said second camera is capturing video.

9. A system for image capture, said system comprising:
an image capture module operable for capturing a first image with a first camera and operable for capturing a second image with a second camera, wherein said first image has a first resolution and said second image has a second resolution, and wherein said second resolution is lower than said first resolution;
a downsampling module operable to downsample said first image to said second resolution to form a third image; and
an image output module operable to output a stereoscopic image comprising said second image and said third image.

10. The system as described in claim 9 wherein said stereoscopic image is a video frame.

11. The system as described in claim 9 wherein said image capture module is operable to capture said first image and said second image coincidentally.

12. The system as described in claim 9 wherein said second camera is operable to capture said second image in less time than said first camera is operable to capture said first image.

13. The system as described in claim 9 wherein said first camera operates at a first power consumption level and said second camera operates at a second power consumption level, and wherein said first power consumption level is greater than said second power consumption level.

14. The system as described in claim 9 wherein said downsampling module is operable to downsample said first image by averaging a plurality of pixels of said first image to include in said third image.

15. The system as described in claim 9 wherein said first camera comprises a first sensor and said second camera comprises a second sensor, and wherein said first sensor and said second sensor share a common aperture.

16. A computer-readable storage medium having stored thereon, computer executable instructions that, if executed by a computer system cause the computer system to perform a method of capturing a stereoscopic image, said method comprising:
capturing a first image with a first camera;
capturing a second image with a second camera, wherein said first image has a first resolution and said second image has a second resolution, and wherein said second resolution is lower than said first resolution;
determining a third image based on downscaling said first image to said second resolution; and
outputting a stereoscopic image comprising said second image and said third image.

17. The computer-readable storage medium as described in claim 16 wherein said stereoscopic image is a video frame.

18. The computer-readable storage medium as described in claim 16 wherein said first image and said second image are captured substantially simultaneously.

19. The computer-readable storage medium as described in claim 16 wherein said first camera comprises a first sensor and said second camera comprises a second sensor, and wherein said first sensor and said second sensor share a single aperture.

20. The computer-readable storage medium as described in claim 16 wherein said downscaling said first image comprises determining an average value of a plurality of pixels of said first image to include in said third image.
